(19) United States
(12) Patent Application Publication
(10) Pub. No.: US 2014/0238636 A1
(43) Pub. Date: Aug. 28, 2014

(54) COOLING VEHICLE COMPONENTS

(71) Applicant: McLaren Automotive Limited, Woking (GB)

(72) Inventors: Dan PARRY-WILLIAMS, Woking (GB); Ian Gough, Woking (GB)

(73) Assignee: McLaren Automotive Limited, Woking (GB)

(21) Appl. No.: 14/010,319

(22) Filed: Aug. 26, 2013

(30) Foreign Application Priority Data
Feb. 26, 2013 (GB) 1303403.8

(51) Int. Cl. B60K 11/06; B60K 15/01

(52) U.S. Cl. CPC B60K 11/06; B60K 15/01
USPC 165/44; 180/69.4

(57) ABSTRACT

A vehicle includes a heat source, a duct system communicating via openings with the exterior of the vehicle and a chamber housing temperature-sensitive components of the vehicle, the openings of the duct system being arranged such that: motion of the vehicle generates a pressure difference between openings of the duct system so as to drive a cooling airflow through the chamber when the vehicle is in motion; and one opening is higher than another of the openings so as to promote a cooling airflow through the chamber by convection when the vehicle is stationary; the chamber being within sufficient proximity to the heat source so as to be capable of reaching temperatures high enough to effectively drive the convection flow and both said airflows being isolated from any airflow to the heat source.

### CROSS-REFERENCE TO RELATED APPLICATIONS

This patent application claims priority to Great Britain Patent Application GB 1303403.8, filed Feb. 26, 2013, entitled “Cooling Vehicle Components,” which is incorporated by reference.

### BACKGROUND

This invention relates to an apparatus for providing cooling to components of a vehicle, particularly components that are in proximity to a heat source.

A typical vehicle will contain many heat sources, for example the brakes; the engine if the vehicle is powered by an internal combustion engine; and electric motors and batteries if the vehicle is an electric or hybrid vehicle. It is often the case that, due to packaging and practicality requirements, temperature-sensitive components of a vehicle must be in relatively close proximity to these heat sources. For example, the engine bay of a typical vehicle will contain components including the battery, fuse box, brake and clutch fluid reservoir and coolant reservoir in addition to the engine. Operating the vehicle can cause these components to be heated to a point where the component is no longer performing optimally, or in extreme cases could cause a component to fail.

Several methods are known for providing cooling to temperature-sensitive components within a vehicle. One method that is suitable when the heat source is the engine of the vehicle is to simply increase the size of the engine bay, which allows the temperature-sensitive components in the engine bay to be placed further away from the engine. However, this can lead to an increase in vehicle size which can result in a decrease in vehicle performance and aerodynamic efficiency. Another method is to utilise airflow into the engine bay through a forward facing grille when the vehicle is in motion as a means of cooling. The airflow resulting from the vehicle's motion can be an effective coolant, but has the obvious disadvantage that it only provides a cooling effect whilst the vehicle is in motion. Consequently, it is common for vehicles to have a fan situated in the engine bay so as to provide a cooling airflow to components when the vehicle is stationary. The use of such a fan has the disadvantage of increased weight and power consumption. There is thus a need for an improved method of cooling heat-sensitive components of a vehicle, particularly those that are in proximity to a heat source.

### BRIEF SUMMARY OF INVENTION

According to one aspect of the present invention there is provided a vehicle comprising a heat source, a duct system communicating via openings with the exterior of the vehicle and a chamber housing temperature-sensitive components of the vehicle, the openings of the duct system being arranged such that: motion of the vehicle generates a pressure difference between openings of the duct system so as to drive a cooling airflow through the chamber when the vehicle is in motion; and one opening is higher than another of the openings so as to promote a cooling airflow through the chamber by convection when the vehicle is stationary; the chamber being within sufficient proximity to the heat source so as to be capable of reaching temperatures high enough to effectively drive the convection flow and both said airflows being isolated from any airflow to the heat source.

The chamber may be positioned within an engine bay of the vehicle.

The vehicle may further comprise an engine cover configured to form part of the boundary of the chamber when fitted in place to the body of the vehicle.

The heat source may be arranged such that motion of the vehicle drives an airflow to the heat source, the airflow to the heat source being distinct from the airflow through the chamber. The heat source may be configured to use the airflow for a purpose other than cooling.

The propensity for degradation of the components housed in the chamber in a temperature elevated environment may be greater than that of the heat source. The heat source may have a cooling mechanism for use when the vehicle is stationary that is distinct from the cooling airflow through the chamber by convection.

The duct system may comprise a first and a second opening. The first opening may be on an outer surface of the vehicle such that air flowing over the outer surface when the vehicle is in motion is driven through the chamber via the first opening. The second opening may be in a wheelarch of the vehicle such that when the vehicle is in motion air is driven into the chamber via the first opening and driven from the chamber into the wheelarch via the second opening. The second opening may be on an outer surface on the underside of the vehicle such that motion of the vehicle causes air to be driven into the chamber via the first opening and driven from the chamber to underneath the body of the vehicle via the second opening. The outer surface on which the second opening is located may be at the diffuser. The first opening may be higher than the second opening such that the cooling airflow through the chamber by convection when the vehicle is stationary is in the opposite direction to the cooling airflow through the chamber when the vehicle is in motion. The second opening may be higher than the first opening such that the cooling airflow through the chamber by convection when the vehicle is stationary is in the same direction to the cooling airflow through the chamber when the vehicle is in motion. The said higher opening may be positioned on an upper outer surface of the body of the vehicle. The higher opening may be covered by a grille.

The vehicle may comprise an engine and/or an electric motor and/or a battery. The heat source may be any one or more of an engine, an electric motor and a battery.

According to a second aspect of the invention there is provided a vehicle comprising a fuel filler opening, the fuel filler opening being equipped with a bowl for receiving fuel overflowing from the filler opening, and the vehicle having a drain route for fuel that runs from a drain opening in the bowl and into a chamber defined by a body cavity of the vehicle.

The body cavity may be in a C pillar of the vehicle. One or more of the side walls of the chamber may be defined by the body cavity and/or by a structural monocoque of the vehicle. One or more of the side walls of the chamber may be external walls of the vehicle.

Fuel following the drain route may be able to contact the interior surface of walls defining the body cavity.

The body cavity may be defined by a hollow fibre-reinforced composite structure.

The drain route may include a chamber as set out above.

The fuel filler opening may be located on an upward facing part of the vehicle's exterior.

### BRIEF DESCRIPTION OF THE DRAWINGS

The present invention will now be described by way of example with reference to the following drawings. In the drawings:

FIG. 1 is a simplified schematic diagram of a vehicle comprising a first example of a chamber and duct system.

FIG. 2 is a simplified schematic diagram of a vehicle comprising a second example of a chamber and duct system.

FIG. 3 is a simplified schematic diagram of a third example of a chamber and duct system.

FIG. 4 illustrates the rear of a vehicle having a fuel drainage system.

### DETAILED DESCRIPTION

The apparatus described below provides a means of cooling components of a vehicle in proximity to a heat source. Cooling can be provided to the components both when the vehicle is in motion and when the vehicle is stationary without the necessary use of an active cooling system such as a fan.

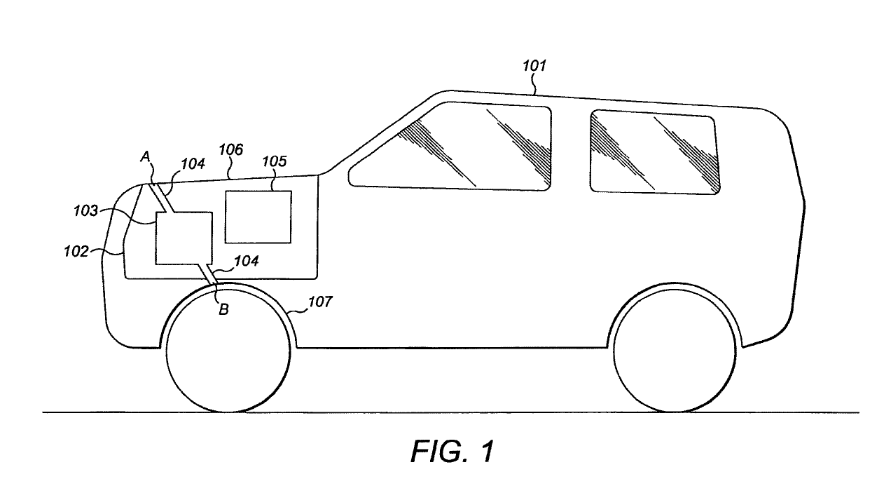

FIG. 1 shows an example of an apparatus used to cool components of a vehicle in proximity to a heat source. A vehicle 101 comprises an engine bay 102. Located within the engine bay is a chamber 103, a duct system 104 and an engine 105, protectable with an engine cover 106. The chamber 103 is used to house temperature-sensitive components of the vehicle that for practical reasons, e.g. because of packaging constraints or because of how they interact with other components of the engine, need to be within relatively close proximity to the engine. When the vehicle is operating the engine 105 is a heat source. Temperature-sensitive components that might be located in chamber 103 could be, for example, a battery, a fuse box or brake and clutch fluid reservoirs. The duct system 104 provides a potential path for airflow between the chamber and the exterior of the vehicle. In the example of FIG. 1 the duct system forms two channels to the chamber from the exterior of the vehicle via two respective openings labelled A and B. Opening A is on the engine cover 106 and opening B is in a wheelarch 107 of the vehicle.

There is airflow over the body of the vehicle when the vehicle is in motion. The airflow will create regions of relatively high and low pressure around the exterior of the vehicle. In this example the aerodynamic properties of the vehicle are such that airflow will cause the pressure over the engine cover in the region of opening A to be higher than the pressure within the wheelarch in the region of opening B. The resulting pressure difference between openings A and B drives an airflow from opening A to opening B, resulting in an airflow through the chamber 103. This airflow acts to cool the components housed in the chamber when the vehicle is in motion.

In certain situations the engine may continue to heat the components inside the chamber when the vehicle is stationary, for example because the engine is still running, or because even after it has been turned off the engine can remain hot for a significant period of time. When the vehicle is stationary there is no dynamic airflow over the exterior of the vehicle to generate a pressure differential between openings A and B and so drive a cooling airflow through the chamber. Nevertheless, because opening A is higher than opening B a cooling flow can be driven through the chamber 103 by convection when the vehicle is stationary. If, when the vehicle is stationary, the engine continues to heat the components housed in the chamber, the heated air inside the chamber rises through the duct system and out of opening A, drawing cooler air into the chamber via opening B. This convection-driven airflow provides a cooling mechanism for the components inside the chamber when the vehicle is stationary, without the need for an active cooling device such as a fan. Furthermore, convective cooling in this chamber and duct system has the advantage of being self-regulating: the higher the temperature inside the chamber (and therefore the more urgent the need for cooling), the stronger the cooling convection flow will be through the chamber. If an active cooling device is not required to cool the components in the chamber 103 the size of the engine bay can be reduced, which can have the advantage of increased aerodynamic efficiency and vehicle performance.

The packaging efficiency of the chamber within the engine bay can be enhanced by configuring the engine cover itself such that it forms an integral part of the structure of the chamber when the engine cover is fitted in place to the body of the vehicle. For example, a portion of the engine cover may form the upper surface of the chamber when the engine cover is in place on the vehicle and covering the engine bay. Similarly, a portion of a cover for the wheel arch or under-tray of the vehicle could form an integral part of the lower structure of the chamber. A section of the duct system 104 leading from the chamber 103 to the exterior of the vehicle could be of negligible length on a side where the chamber 103 is formed close to the surface of the vehicle.

The chamber may be thermally insulated to limit heating of the housed components by the heat source, for example by supplementing a structural wall of the chamber with an adjacent insulating layer such as a layer of foam or a reflective sheet.

The duct system and chamber may be in conjunction air-tight between the openings of the duct system at the outer surface of the vehicle. In this way air within the chamber and the duct system is isolated from air elsewhere within the body of the vehicle, for example the airflow to the engine. This promotes efficient cooling due to dynamic pressure differences or convection, and helps to resist heating of components in the chamber 103 by surrounding hot air.

The airflow requirements of the engine differ from those of the components housed in the chamber when the vehicle is stationary and when the vehicle is in motion. When the vehicle is in motion, the airflow through the chamber is used to cool components housed therein whereas the engine requires air for use in combustion. When the vehicle is stationary, the cooling requirements of the components housed in the chamber differ from the cooling requirement of the engine. Typically the engine is designed to operate at higher temperatures than the components housed in the chamber and in many vehicles the engine has its own cooling system. Isolating the airflow through the duct system and chamber from the airflow to the engine advantageously allows each airflow to be adapted for its particular requirements.

In the example implementation shown in FIG. 1, air flows from opening A through to opening B when the vehicle is in motion. When the vehicle is stationary, the airflow is driven by convection from opening B through to opening A. Thus the flow direction through the chamber due to convection when the vehicle is stationary is reversed compared to the flow direction due to dynamic pressure differences when the vehicle is in motion. In an alternative embodiment to that shown in FIG. 1, the chamber and duct system may be configured such that the higher opening exits at a location on the bodywork that is at a lower pressure when the vehicle is in motion than the location where the lower opening exits. If this configuration is adopted, the flow direction through the chamber when the vehicle is stationary is the same as the flow direction through the chamber when the vehicle is in motion.

It will be appreciated that the flow direction could change even when the vehicle is stationary. For example, a strong gust of wind over the vehicle could be sufficient to generate a dynamic pressure differential that overcomes the convective flow due to heat in chamber 103. Similarly, if the convective flow is strong it could surpass the tendency to dynamically-driven flow at low vehicle velocities.

The upper opening could be on an upper and/or upwardly-facing outer surface of the body of the vehicle. It could be protected by a grille to prevent unwanted objects entering the duct system. It could be inside a panel of the vehicle. The lower opening could be on a lower and/or downwardly facing outer surface of the body of the vehicle. It could be protected by a grille to prevent unwanted objects entering the duct system. It could be inside a panel of the vehicle. One of the openings could be at a location that is substantially unaffected by dynamic pressure changes when the vehicle is in motion. If either opening were to be at a location that remains substantially at atmospheric pressure whilst the vehicle is in motion (e.g. by venting into a body panel of the vehicle), flow could still be driven dynamically if the lower opening were at a location that experienced a pressure different from atmospheric pressure when the vehicle was in motion.

The chamber may be a cross-functional chamber; that is, it may contain multiple fastening points so as to be configurable to house multiple components that require cooling. In this way the chamber may house, in combination or isolation, components of differing functional type. The components could be, for example, electrical, hydraulic and/or mechanical components.

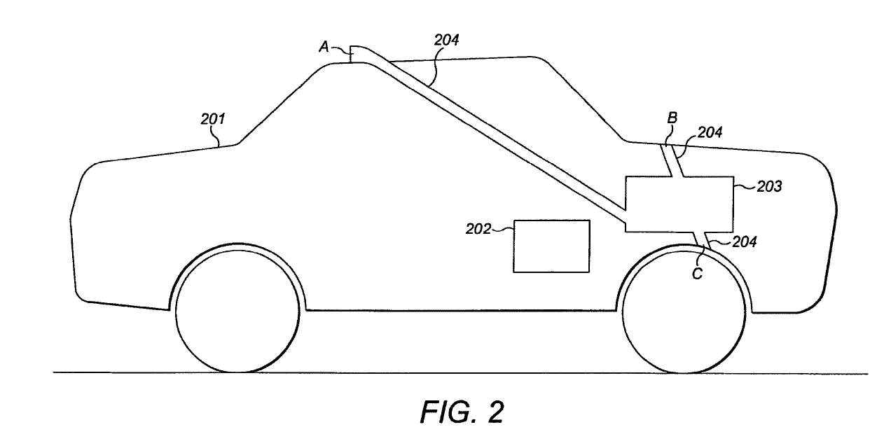

The duct system may comprise more than two openings. FIG. 2 shows an example duct and chamber system where the duct system comprises three openings. In FIG. 2 there is a vehicle 201 with a heat source 202 and a chamber 203 for housing heat sensitive components of the vehicle. The vehicle also comprises a duct system 204 with three openings, labelled as A, B and C.

The chamber and duct system of FIG. 2 is configured such that motion of the vehicle causes airflow over the vehicle that generates a pressure difference across the duct system. The pressure difference causes the pressure at opening A to be greater than the pressure at opening C. This pressure difference drives a cooling airflow through the chamber 203. Opening A could be positioned on the exterior surface of the main body of the vehicle, or alternatively it could be formed from a duct external to the main body of the vehicle, for example a roof scoop. Opening C could be positioned in a wheelarch of the vehicle.

In the duct system shown in FIG. 2, opening B is positioned higher than opening C so that when the vehicle is stationary a cooling airflow can be driven through the chamber by convection. If, when the vehicle is stationary, the heat source continues to heat the components housed in the chamber, or the components in the chamber remain hot, the warm air in the chamber can rise through the duct system out of opening B. This will draw cooler air into the chamber via opening C. In this arrangement the cooling airflow through the chamber when the vehicle is stationary passes through a different set of openings than the cooling airflow through the chamber when the vehicle is in motion. In this embodiment the duct system and chamber may be in conjunction air-tight between the openings of the duct system at the outer surface of the vehicle. In this way air within the chamber and the duct system is isolated from air elsewhere within the body of the vehicle, for example the airflow to the engine.

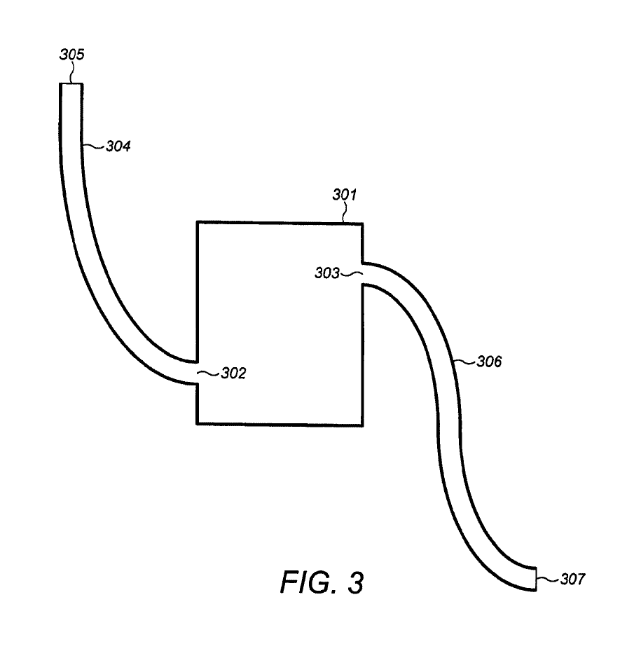

In order for a cooling airflow to be effectively driven through the chamber by convection when the vehicle is stationary it is preferable that one opening of the duct system is positioned higher than another opening of the duct system. However, it is not necessary for one particular opening that connects the chamber to the duct system to be positioned higher than another opening that connects the chamber to the duct system. For example, in the chamber and duct system shown in FIG. 3, chamber 301 has openings 302 and 303. A duct 304 extends between opening 302 and an opening 305. A second duct 306 extends between opening 303 and a second opening 307, the opening 307 being positioned lower than the opening 305. The system shown in FIG. 3 is configured for a cooling flow to be driven through the chamber by convection from opening 307 to opening 305 despite opening 303 being positioned higher than opening 302.

A vehicle such as the one described above could employ a fuel drainage system. Such a fuel drainage system could optionally be integrated with a cooling chamber of the type described above.

The fuel tank of a vehicle is conventionally filled through a filler opening at the exterior of the vehicle. The user inserts a nozzle into the filler opening and dispenses fuel through the opening. For aerodynamic and aesthetic reasons, the filler opening is normally located inboard of the vehicle's outer skin, and can be covered, e.g. by a flap, when it is not in use. Because the filler opening is located inboard, if the user overfills the tank with fuel, fuel can spill out of the opening and into the body of the vehicle. To mitigate this, it is conventional to surround the opening with a bowl which joins to the exterior bodywork of the vehicle, and to run a drain hose through the vehicle from the lowest point of the bowl to the underside of the vehicle. This allows small spills, as would result if the user momentarily overfills the vehicle, to drain away. If the user were to continue dispensing fuel when the tank was full then the rate of fuel flow could be greater than the drain hose could cope with. In a conventional vehicle, that eventuality is mitigated by the fuel filler opening being located on the side of the vehicle. Then, if the user keeps dispensing fuel at such a rate as to overwhelm the drain hose, the excess fuel will spill out of the bowl and run down the side of the vehicle. Hence the excess fuel will not build up in the vehicle. However, in some vehicles particularly sports vehicles, it may be desirable to locate the filler opening on or near the roof. In such a vehicle it is conceivable that fuel spilling out of the bowl could run down the vehicle and enter the vehicle through a gap in the vehicle's exterior panels. It would be desirable for uncontained spillage of that sort to be avoided. One option would be to increase the bore of the drain hose. However, that may be impossible in a tightly packaged vehicle.

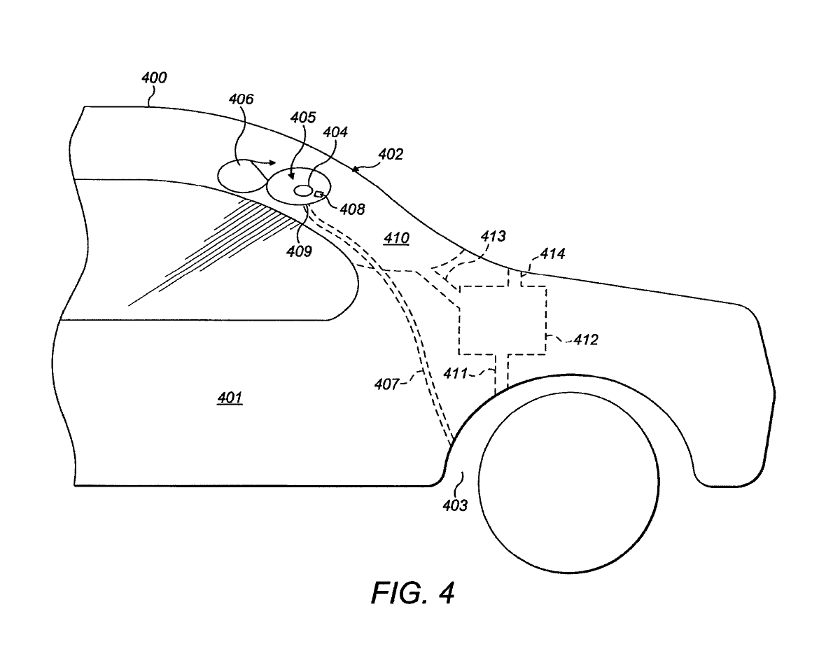

FIG. 4 illustrates the rear of a vehicle having a fuel drain system. The vehicle of FIG. 4 comprises a roof 400, a side body panel 401, a C pillar 402 and a wheelarch 403. A fuel filler opening 404 is located in the C pillar. The fuel filler opening could be on an upward facing part of the vehicle and/or near the upper surface of the vehicle. The fuel filler opening is inboard of the exterior skin of the vehicle. The fuel filler opening is set into a bowl shown at 405 which cups inwards from the exterior skin of the vehicle. When the filler opening is not in use it can be covered by a flap 406. The bowl is sealed to the inner surface of the vehicle's outer skin.

A small diameter drain hose 407 runs from the lowest point in the bowl to the vehicle's wheelarch or floorpan. If fuel is spilled in the bowl it can drain through this hose and out of the vehicle.

If the drain hose is overwhelmed then the fuel level will rise in the bowl 405. An opening 408 in the bowl is located higher than the opening 409 to the hose 407 but lower than the lowest point where the periphery of the bowl meets the exterior of the vehicle. The opening 408 communicates with the body cavity of the vehicle adjacent to the bowl 405. As a result of this arrangement, if the fuel level in the bowl rises to the opening 408 fuel will pour from the bowl into the body cavity of the vehicle rather than flow out over the exterior of the vehicle. This contains the fuel and avoids it running over the exterior surface, potentially entering other parts of the vehicle through panel gaps and the like. Opening 408 is sufficiently large to allow even a high flow rate of fuel to be accommodated.

To drain the fuel from body cavity 410 the cavity communicates with the wheelarch 403 via a conduit 411. Conduit 411 could run directly from cavity 410 to the wheelarch. However, conveniently the lowest part of cavity 410 communicates with a chamber 412, for example via a conduit 413. That chamber is a cooling chamber of the type described above, which can cool components inside it by convection or dynamic pressure differences through conduit 411 and another conduit 414 which runs from the chamber 412 to the upper side of the vehicle. In this embodiment, the chamber 412 and the conduit 411 serve the dual purposes of cooling components in the chamber and providing a drain for fuel in body cavity 410.

The hose 407 could pass at least partially through cavity 410. However, fuel in hose 407 is contained within the hose, whereas fuel spilling through opening 408 will contact the interior of the bodywork of the vehicle defining cavity 410. The bodywork may be one or more walls whose exterior defines the exterior surface of the vehicle. The bodywork may be part of a monocoque vehicle body.

The cooling chamber of FIG. 4 could function as for any of the cooling chambers described with reference to FIGS. 1 to 3.

The body cavity 410 could be defined by a hollow structural element of the vehicle such as a welded metal box section or a hollow composite beam. The system of FIG. 4 is particularly useful if the body cavity is defined by a hollow composite structure, particularly of a resinous and/or fibre reinforced material such as a carbon fibre composite, because such materials are more reliably fluid-tight than some others used for vehicle manufacture.

In the example duct and chamber systems shown in FIGS. 1 and 2, a cooling airflow is driven through the chamber and into a wheelarch via an opening when the vehicle is in motion. As an alternative to a wheelarch the opening could instead be into any suitable region that is at relatively low pressure when the vehicle is in motion. For example, the opening could be positioned on the underside of the body of the vehicle, in particular it could be positioned in a diffuser of the vehicle.

The concepts described above have been described by way of example with the heat source being the engine of the vehicle, and the chamber being positioned in the engine bay of the vehicle. Alternatively, the heat source may be a battery or electric motor, which may be suitable for an electric or hybrid vehicle. The chamber could be in any suitable location in the vehicle, for example in an engine bay, passenger compartment or luggage bay.

The concepts described above can be equally applied to any configuration of chamber and duct system so long as there is a suitable pressure difference across the duct system when the vehicle is in motion to drive an airflow through the chamber, and a suitable height difference between the openings so as to drive an airflow through the chamber by convection when the vehicle is stationary.

As can be appreciated, there are many aspects and embodiments of the invention. Presented below in example claim format are various embodiments and aspects of the invention. The invention may include any one or combination of the aspects recited.

1. A vehicle comprising a heat source, a duct system communicating via openings with the exterior of the vehicle and a chamber housing temperature-sensitive components of the vehicle, the openings of the duct system being arranged such that:

motion of the vehicle generates a pressure difference between openings of the duct system so as to drive a cooling airflow through the chamber when the vehicle is in motion; and

one opening is higher than another of the openings so as to promote a cooling airflow through the chamber by convection when the vehicle is stationary;

the chamber being within sufficient proximity to the heat source so as to be capable of reaching temperatures high enough to effectively drive the convection flow and both said airflows being isolated from any airflow to the heat source.

2. A vehicle as claimed in claim 1, wherein the chamber is positioned within an engine bay of the vehicle.

3. A vehicle as claimed in claim 1 or 2, wherein the vehicle further comprises an engine cover configured to form part of the boundary of the chamber when fitted in place to the body of the vehicle.

4. A vehicle as claimed in any preceding claim, wherein the heat source is arranged such that:

motion of the vehicle drives an airflow to the heat source, the airflow to the heat source being distinct from the airflow through the chamber, and the heat source being configured to use the airflow for a purpose other than cooling.

5. A vehicle as claimed in any preceding claim, wherein the propensity for degradation in a temperature elevated environment is greater for the components housed in the chamber than for the heat source, the heat source having a cooling mechanism for use when the vehicle is stationary that is distinct from the cooling airflow through the chamber by convection.

6. A vehicle as claimed in any preceding claim, wherein the duct system comprises a first and a second opening.

7. A vehicle as claimed in claim 6, wherein the first opening is on an outer surface of the vehicle such that air flowing over the outer surface when the vehicle is in motion is driven through the chamber via the first opening.

8. A vehicle as claimed in claim 6 or 7, wherein the second opening is in a wheelarch of the vehicle such that when the vehicle is in motion air is driven into the chamber via the first opening and driven from the chamber into the wheelarch via the second opening.

9. A vehicle as claimed in claim 6 or 7, wherein the second opening is on an outer surface on the underside of the vehicle such that motion of the vehicle causes air to be driven into the chamber via the first opening and driven from the chamber to underneath the body of the vehicle via the second opening.

10. A vehicle as claimed in claim 9 comprising a diffuser, wherein the outer surface on which the second opening is located is at the diffuser.

11. A vehicle as claimed in any of claims 7 to 10, wherein the first opening is higher than the second opening such that the cooling airflow through the chamber by convection when the vehicle is stationary is in the opposite direction to the cooling airflow through the chamber when the vehicle is in motion.

12. A vehicle as claimed in any of claims 7 to 10, wherein the second opening is higher than the first opening such that the cooling airflow through the chamber by convection when the vehicle is stationary is in the same direction to the cooling airflow through the chamber when the vehicle is in motion.

13. A vehicle as claimed in any preceding claim, wherein the said higher opening is positioned on an upper outer surface of the body of the vehicle.

14. A vehicle as claimed in claim 13, wherein the higher opening is covered by a grille.

15. A vehicle as claimed in any preceding claim comprising an engine, wherein the heat source is the engine of the vehicle.

16. A vehicle as claimed in any of claims 1 to 15 comprising an electric motor, wherein the heat source is the electric motor.

17. A vehicle as claimed in any of claims 1 to 15 comprising a battery, wherein the heat source is the battery.

18. A vehicle comprising a fuel filler opening, the fuel filler opening being equipped with a bowl for receiving fuel overflowing from the filler opening, and the vehicle having a drain route for fuel that runs from a drain opening in the bowl and into a chamber defined by a body cavity of the vehicle.

19. A vehicle as claimed in claim 18, wherein the body cavity is in a C pillar of the vehicle.

20. A vehicle as claimed in claim 18 or 19, wherein the side walls of the chamber are defined by the body cavity.

21. A vehicle as claimed in any of claims 18 to 20, wherein fuel following the drain route can contact the interior surface of walls defining the body cavity.

22. A vehicle as claimed in any of claims 18 to 21, wherein the body cavity is defined by a hollow fibre-reinforced composite structure.

23. A vehicle as claimed in any of claims 18 to 22, wherein the drain route includes a chamber as claimed in any of claims 1 to 17.

24. A vehicle as claimed in any of claims 18 to 23, wherein the fuel filler opening is located on an upward facing part of the vehicle's exterior.

25. A vehicle substantially as herein described with reference to the accompanying drawings.

The applicant hereby discloses in isolation and combination each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of such features. In view of the foregoing description it will be evident to a person skilled in the art that various modifications can be made within the scope of the invention.

1. A vehicle comprising a heat source, a duct system communicating via openings with the exterior of the vehicle and a chamber housing temperature-sensitive components of the vehicle, the openings of the duct system being arranged such that:
motion of the vehicle generates a pressure difference between openings of the duct system so as to drive a cooling airflow through the chamber when the vehicle is in motion; and
one opening is higher than another of the openings so as to promote a cooling airflow through the chamber by convection when the vehicle is stationary;
the chamber being within sufficient proximity to the heat source so as to be capable of reaching temperatures high enough to effectively drive the convection flow and both said airflows being isolated from any airflow to the heat source.

2. A vehicle as claimed in claim 1, wherein the chamber is positioned within an engine bay of the vehicle.

3. A vehicle as claimed in claim 1, wherein the vehicle further comprises an engine cover configured to form part of the boundary of the chamber when fitted in place to the body of the vehicle.

4. A vehicle as claimed in claim 1, wherein the heat source is arranged such that:
motion of the vehicle drives an airflow to the heat source, the airflow to the heat source being distinct from the airflow through the chamber, and the heat source being configured to use the airflow for a purpose other than cooling.

5. A vehicle as claimed in claim 1, wherein the propensity for degradation in a temperature elevated environment is greater for the components housed in the chamber than for the heat source, the heat source having a cooling mechanism for use when the vehicle is stationary that is distinct from the cooling airflow through the chamber by convection.

6. A vehicle as claimed in claim 1, wherein the duct system comprises a first and a second opening.

7. A vehicle as claimed in claim 6, wherein the first opening is on an outer surface of the vehicle such that air flowing over the outer surface when the vehicle is in motion is driven through the chamber via the first opening.

8. A vehicle as claimed in claim 6, wherein the second opening is in a wheelarch of the vehicle such that when the vehicle is in motion air is driven into the chamber via the first opening and driven from the chamber into the wheelarch via the second opening.

9. A vehicle as claimed in claim 6, wherein the second opening is on an outer surface on the underside of the vehicle such that motion of the vehicle causes air to be driven into the chamber via the first opening and driven from the chamber to underneath the body of the vehicle via the second opening.

10. A vehicle as claimed in claim 9 comprising a diffuser, wherein the outer surface on which the second opening is located is at the diffuser.

11. A vehicle as claimed in claim 7, wherein the first opening is higher than the second opening such that the cooling airflow through the chamber by convection when the vehicle is stationary is in the opposite direction to the cooling airflow through the chamber when the vehicle is in motion.

12. A vehicle as claimed in any of claim 7, wherein the second opening is higher than the first opening such that the cooling airflow through the chamber by convection when the vehicle is stationary is in the same direction to the cooling airflow through the chamber when the vehicle is in motion.

13. A vehicle as claimed in claim 1, wherein the said higher opening is positioned on an upper outer surface of the body of the vehicle.

14. A vehicle as claimed in claim 13, wherein the higher opening is covered by a grille.

15. A vehicle as claimed in claim 1 comprising an engine, wherein the heat source is the engine of the vehicle.

16. A vehicle as claimed in claim 1 comprising an electric motor, wherein the heat source is the electric motor.

17. A vehicle as claimed in claim 1 comprising a battery, wherein the heat source is the battery.

18. A vehicle comprising a fuel filler opening, the fuel filler opening being equipped with a bowl for receiving fuel overflowing from the filler opening, and the vehicle having a drain route for fuel that runs from a drain opening in the bowl and into a chamber defined by a body cavity of the vehicle.

19. A vehicle as claimed in claim 18, wherein the body cavity is in a C pillar of the vehicle.

20. A vehicle as claimed in claim 18, wherein the side walls of the chamber are defined by the body cavity.

21. A vehicle as claimed in claim 18, wherein fuel following the drain route can contact the interior surface of walls defining the body cavity.

22. A vehicle as claimed in claim 18, wherein the body cavity is defined by a hollow fibre-reinforced composite structure.

23. A vehicle as claimed in claim 18, wherein the drain route includes a chamber as claimed in claim 1.

24. A vehicle as claimed in claim 23, wherein the fuel filler opening is located on an upward facing part of the vehicle's exterior.

25. A vehicle as claimed in claim 18, wherein the fuel filler opening is located on an upward facing part of the vehicle's exterior.
